(19) United States
(12) Patent Application Publication
(10) Pub. No.: US 2009/0095116 A1
(43) Pub. Date: Apr. 16, 2009

(54) BICYCLE HANDLEBAR

(75) Inventors: Graham Barnes, Surrey (GB); Roger Lionel Sparrow, West Sussex (GB)

Correspondence Address: BANNER & WITCOFF, LTD., TEN SOUTH WACKER DRIVE, SUITE 3000, CHICAGO, IL, 60606, US

(73) Assignee: ULTIMATE SPORTS ENGINEERING LIMITED, Petworth, West Sussex (GB)

(21) Appl. No.: 12/282,450

(22) PCT Filed: Mar. 9, 2007
(86) PCT No.: PCT/GB2007/000830

§ 371 Date: Sep. 10, 2008

(30) Foreign Application Priority Data
Mar. 10, 2006 (GB) 0604810.2
Jun. 12, 2006 (GB) 0611588.5

(51) Int. Cl. B62K 21/12; F16C 1/10

(52) U.S. Cl. 74/502.2; 74/551.8

(57) ABSTRACT

A handlebar for attachment to a cycle is disclosed. The handlebar comprises a generally horizontally extending cross-piece portion and at least one brake operating lever disposed at least partially within the forward horizontal projection of said cross-piece portion. Various arrangements and shapes of brake levers are also disclosed. A common clamp for securing handlebar grip extensions and armrests is also disclosed

This invention relates to certain improvements in bicycles, in particular, the reduction of aerodynamic drag for bicycles which are intended for competitive use.

Cycle races and time-trials are highly competitive. Particularly in the case of races and time-trials run over longer distances, an important factor that can affect the performance of a rider is the amount of aerodynamic drag which the rider and bike present. Clearly the lower the drag, the greater the speed which can be achieved for a given expenditure of energy. To give an example of this, U.S. Pat. No. 4,750,754 discloses a modification to conventional racing handlebars to provide a pair of forwardly and inwardly extending handles which a rider can grip with his or her forearms resting on the conventional cross-piece portion. This causes the rider to adopt a position which presents a forward facing shape that minimises the drag created.

However, the Applicant has further appreciated that the brake operating levers and supports therefor which are provided on the handlebars have an appreciable effect on the overall aerodynamic drag of the bicycle. It has further appreciated that this drag can be reduced by repositioning and/or reconfiguring the brake operating components.

When viewed from a first aspect the present invention provides a handlebar for attachment to a cycle, the handlebar comprising a generally horizontally extending cross-piece portion and at least one brake operating lever disposed at least partially within the forward horizontal projection of said cross-piece portion.

Thus it will be seen by those skilled in the art that in accordance with the invention a brake lever is located on the handlebar so as at least partially to mask the cross-piece of the handlebar. This represents a significant reduction in the aggregate frontal area presented by the handlebar as compared to conventional arrangements which have both the brake lever and mounting hood located in the full contact air stream. It has been found for example that in accordance with preferred embodiments of the invention a reduction in drag equivalent to about 10 to 15 watts can be achieved at a speed of approximately 27 miles per hour which gives a time saving of the order of 1 to 1.5 seconds per mile. It will be appreciated that this would be extremely significant at the upper levels of competitive cycling.

In discussing the invention reference will be made for the sake of convenience to a single brake lever although it will be appreciated that in most normal applications two brake levers would be provided on opposite sides of the handlebar for operating the front and rear brakes respectively. It is generally preferred that the two brake levers are configured in the same way although this is not strictly essential. It should be appreciated that as used herein horizontal is intended to mean horizontal when the bicycle is on level ground.

The longitudinal axis of the brake lever could be skewed relative to the longitudinal axis of the cross-piece. Depending upon the skew angle, the length and thickness of the brake lever and the vertical height of the cross-piece, this could result in part of the brake lever extending above or below the horizontal forward projection of the cross-piece. In preferred embodiments however the longitudinal axes of the brake lever and cross-piece are substantially parallel. Similarly, even if they are parallel part of the brake lever could extend beyond the horizontal forward projection of the cross-piece. For example, other constructional, ergonomic or safety factors might mean that the lever is not fully within the shadow of the cross-piece. However, such arrangements will still derive advantage from their application of the principle of the invention although since in general the degree of advantage obtainable would be dependent upon the extent of overlap, in the most preferred embodiments the brake lever is entirely within the horizontal forward projection of the cross-piece.

The Applicant has further found that the shape of the brake lever can have an impact on its aerodynamic performance. In preferred embodiments of the invention the brake lever has a cross-sectional profile which has a width, defined as its dimension in a direction normal to both its longitudinal axis and its pivot axis, greater than its height, defined as its dimension in the direction parallel to its pivot axis. More preferably the width is at least twice the height e.g. between two and three times the height. However it could be more than three times the height.

Such a brake lever is believed to be novel and inventive in its own right and thus when viewed from a second aspect the invention provides a brake operating lever for attachment to a bicycle, said brake operating lever having a longitudinal handle portion extending from a pivot axis, the handle portion having a width greater than its height. The invention also extends to such a lever mounted for pivotal movement to a mounting hood and to a handlebar having such a brake operating lever mounted thereto. As above, the width is preferably at least twice e.g. between two and three times the height of the lever although could be more.

Many sectional profile shapes could be used—e.g. rectangular. Preferably though the lever has a cross-sectional profile which is generally curved, e.g. an oval and most preferably has its leading edge blunter than its trailing edge, i.e. it has a general aerofoil shape. In some embodiments envisaged the profile could be asymmetric—e.g. with a convex upper surface and a concave lower surface akin to the general shape of a lifting aerofoil. In preferred embodiments however the profile is symmetric between upper and lower parts.

In some preferred embodiments in accordance with either of the aforementioned aspects of the invention, the distal end of the lever is provided with a finial portion which may be formed integrally with it or attached thereto. Preferably the finial portion also has a shape including an aerofoil cross-section in order to minimise its wind resistance. A finial portion might be useful for example to reduce the risk of a rider's hands slipping off the lever or as a safety measure to avoid having a sharp end at the edge of the lever.

It is similarly preferred that, where provided, the brake lever hood inside which the lever is pivotally mounted and typically attached to a brake cable, also has a width greater than its height, more preferably shaped to include an aerofoil shaped cross-sectional profile, i.e. one which is blunter at its leading edge than its trailing edge. Again this encourages a smooth flow of air over it.

The Applicant has recognised making the brake hood more aerodynamic is novel and inventive in its own right and thus when viewed from a further aspect the invention provides a brake assembly for a bicycle comprising a brake lever pivotally mounted with respect to a brake hood about a pivot axis, the brake hood having a cross-sectional profile in a plane parallel to the pivot axis which is wider in a direction normal to the pivot axis than its height in a direction parallel to the pivot axis.

The overall shape of the hood could be a surface of revolution of the aforementioned sectional profile, a different reducing extrusion of the profile a linear extrusion of the profile, or indeed any other suitable shape.

The brake hood is preferably mounted at the outermost end of the cross-piece with the brake lever extending therefrom towards the centre of the handlebar. However, the lever hood could instead by disposed inboard of this location, extending either inwardly or outwardly. Indeed, it is even envisaged that the brake hood could be omitted and the brake lever mounted directly into the cross-piece itself, again extending inwardly or outwardly.

The brake cable could, as is conventional, be clipped to the outer surface of the handlebar and extend in use to the corresponding brake mechanism at the wheel. However, it is preferred that the cable passes inside the cross-piece or other handlebar tubing in order that it is, in preferred embodiments at least, completely concealed at least for its run along the handlebars. This beneficially further assists in minimising wind resistance and at the same time is more aesthetically pleasing.

Whilst horizontally extending brake levers are known for example on mountain bikes, as far as the Applicant is aware they have not previously be proposed in bicycles for competitive racing and time-trials which always have vertically extending brake levers. When viewed from a farther aspect therefore, the invention provides a racing bicycle comprising a handlebar including a cross-piece portion and one or more brake levers mounted so as to be substantially parallel with said cross-piece. As mentioned previously this is of special significance in applications where minimisation of wind resistance is important and in practice such bikes will usually have the forwardly extending handles of the type generally shown in U.S. Pat. No. 4,750,754 and described hereinabove. Thus it is a preferred feature of the above-mentioned aspect of the invention that the bicycle comprises a pair of forwardly extending handles.

According to a further novel and inventive arrangement disclosed herein there is provided a handlebar for a racing bicycle comprising a brake operating lever mounted for pivotal movement about a pivot axis which is outboard of the free end of the lever, said brake lever having a longitudinal axis substantially parallel to a cross-piece of said handlebar.

When viewed from another aspect the invention provides a bicycle handlebar assembly to be incorporated into a bicycle handlebar to retain the extension grips and the armrest pads at the same time by means of a locking bolt, screw or other mechanical fixing.

When viewed from a further aspect the invention provides an assembly for a bicycle handlebar comprising a handlebar extension member, an armrest member and a common fixing means for fixing said extension and armrest members to a handlebar. The invention extends to a bicycle handlebar having such an assembly or preferably a pair thereof affixed to it.

In accordance with this aspect of the invention a handlebar extension, otherwise known as extension grips, and an armrest can be affixed to a handlebar using a single fixing which minimises costs and simplifies assembly.

Preferably the fixing means is adapted to allow the position of the armrest and/or the extension member to be adjusted.

Preferably the fixing means comprises a clamp part adapted selectively to clamp the extension member.

Preferably the armrest is fixed to the clamp part. Preferably the relative orientation between the armrest and the clamp part can be adjusted.

Preferably a compressible collar, e.g. comprising one or more axial slots is interposed between said clamp part and said extension member. This can allow axial and rotational adjustment of the extension member.

Preferably the collar has a partly spherical outer surface. This allows the clamp part to clamp the collar at an oblique angle to the axis of the collar and hence the extension member, thereby allowing the armrest fixed to it to be secured at an angle which is adjustable in two orthogonal directions.

The clamp part preferably comprises a split ring comprising one or more locking bolts, screws or other mechanical fixings. Other variable diameter arrangements—e.g. a jubilee type fixing could be used instead.

Certain preferred embodiments of the invention will now be described, by way of example only, with reference to the accompanying drawings in which:

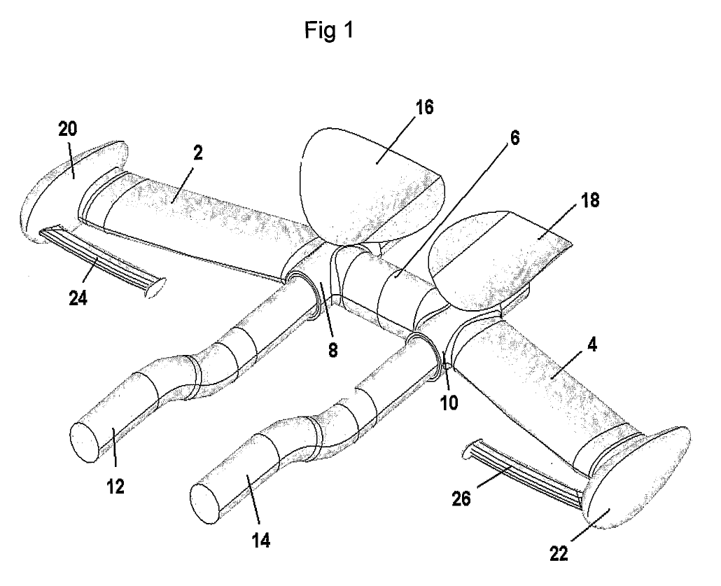

FIG. 1 is a perspective view of a handlebar arrangement in accordance with the invention;

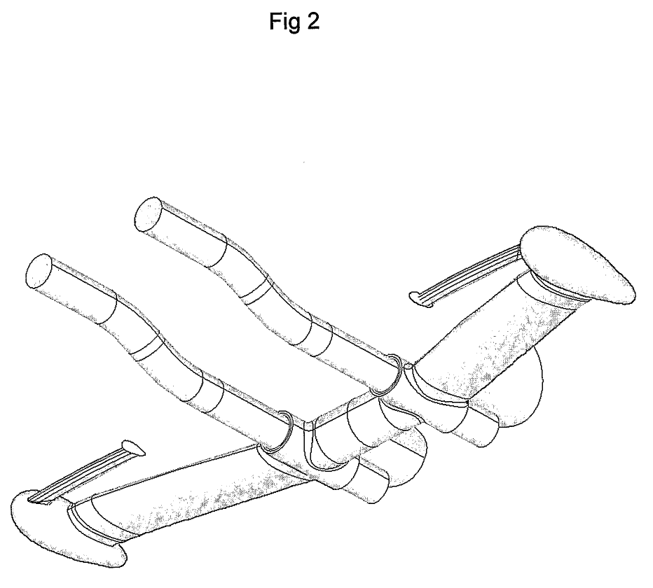

FIG. 2 is a similar view to FIG. 1 but from below;

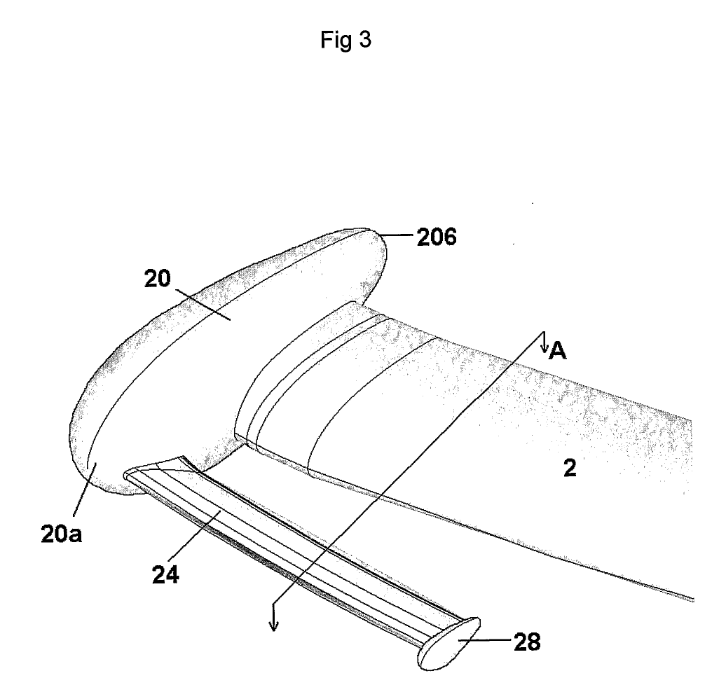

FIG. 3 is an enlarged view of one of the brake levers of FIGS. 1 and 2;

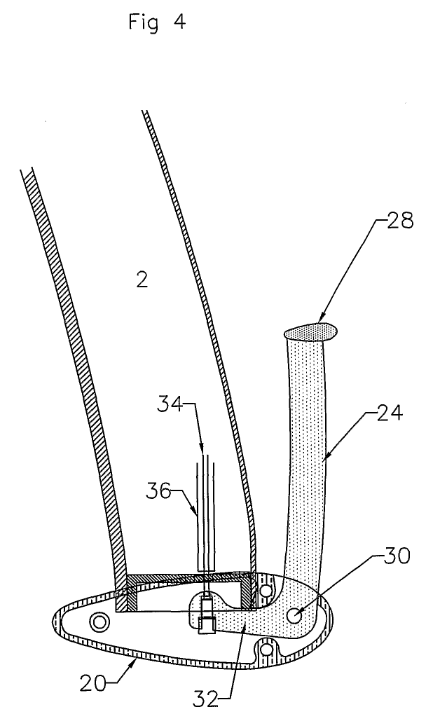

FIG. 4 is a horizontal section view through the components shown in FIG. 3;

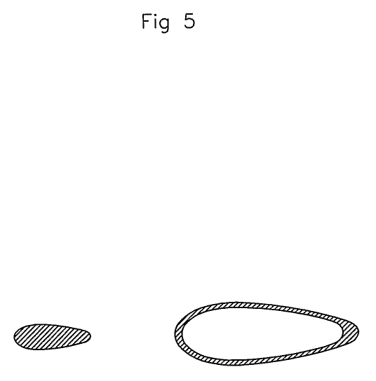

FIG. 5 is a section on the line A..A of FIG. 3;

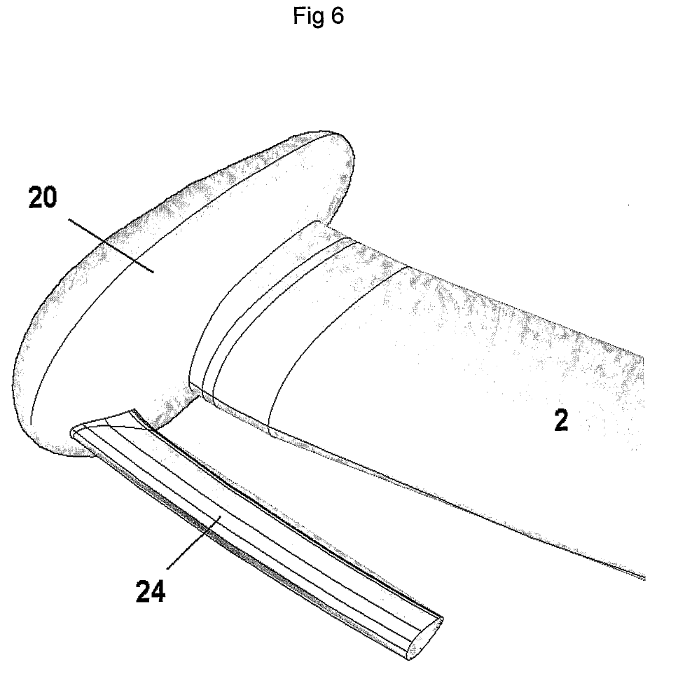

FIG. 6 is a view similar to FIG. 3 showing the lever finial omitted;

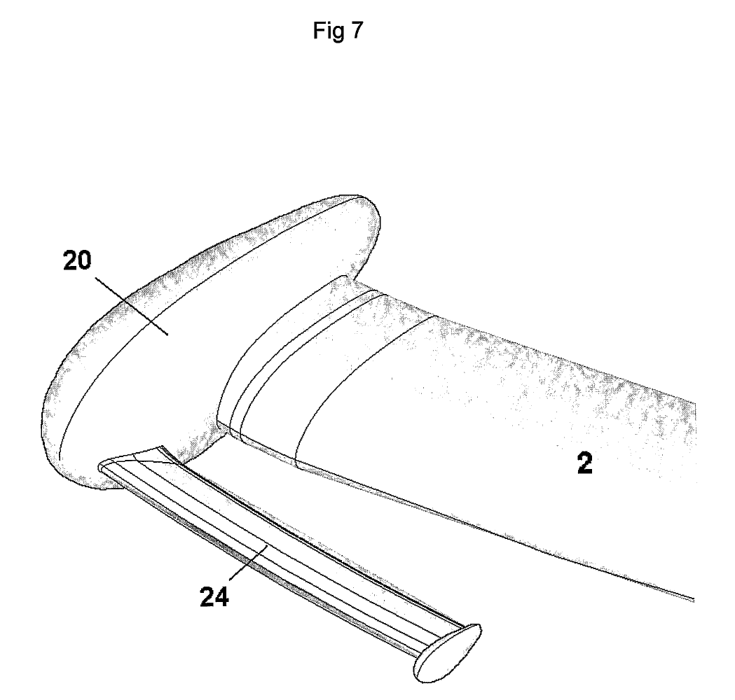

FIG. 7 is a view similar to FIG. 3 of a further embodiment of the invention;

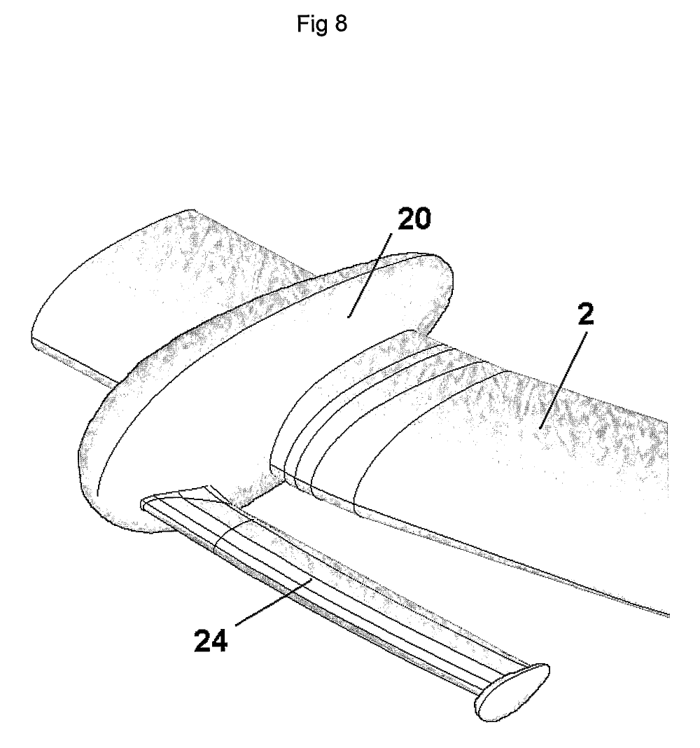

FIGS. 8 to 10 are views similar to FIG. 3 of further embodiments;

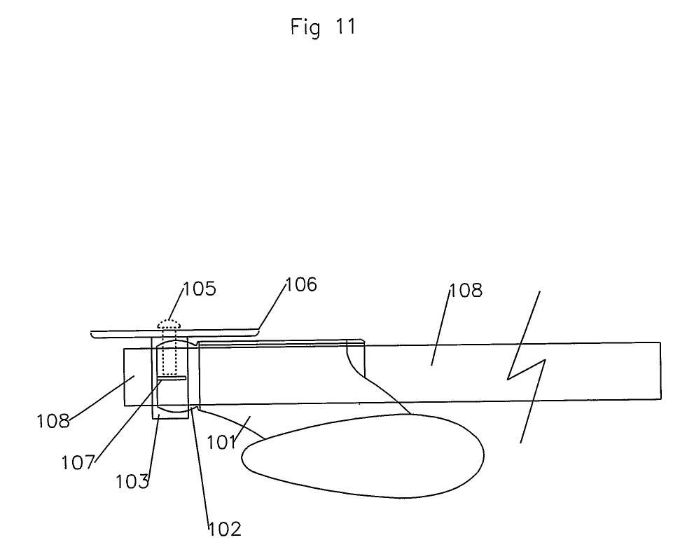

FIG. 11 shows a handlebar assembly embodying a further aspect of the invention;

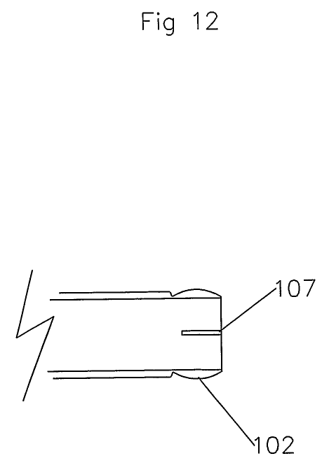

FIG. 12 shows the collar for receiving the handlebar extension of the assembly of FIG. 11; and

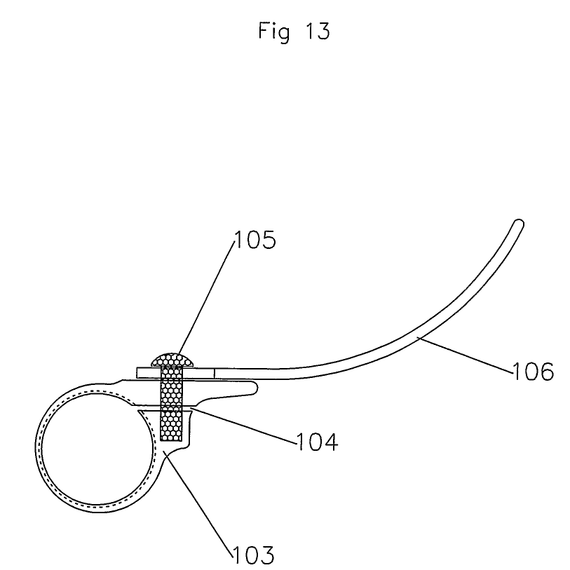

FIG. 13 shows a side elevation of the gripping part an armrest form the assembly of FIG. 11.

FIGS. 1 to 3 show a handlebar arrangement for a bicycle intended for competitive use such as racing or time-trials. It will in use be attached to a bicycle stem by means of a stem clamp in a conventional manner. The handlebars comprise a main cross-piece comprising left and right handle portions 2,4 and a central connecting portion 6. It is the central connecting portion 6 which is clamped by the stem clamp in use. At the junctions between the respective cross-piece handle portions 2,4 and the central connecting portion 6 are a pair of circular bores 8,10 which receive respective forwardly projecting handles 12,14. Mounted to the top of the tubular bores 8,10 and set backwardly therefrom are two forearm rests 16,18 on which a rider can rest his or her forearms whilst gripping the forwardly projecting handles 12,14.

At the outer end of each of the side handles 2,4 are respective brake hoods 20,22 from which brake levers 24,26 extend. Referring to the enlarged view of FIG. 3, it may be seen that the brake hood 20 is the shape of a generally aerofoil-shaped sectional profile which has been revolved around its long axis. Thus the leading surface 20a is of blunter shape than its trailing surface 20b. This overall shape helps to minimise wind resistance. A finial portion 28 is provided at the end of the lever 24 which can help, inter alia, with preventing a rider's hand from slipping off the lever. The shape of the finial portion 28 matches that of the brake hood 20.

Functioning of the brake operation lever 24 may be seen from FIG. 4. The lever 24 is part of a bell crank arrangement with arms of unequal length. The lever 24 is pivoted about a pivot axis 30 inside the brake hood 20 and extends approximately towards the centre of the handlebar. In other words the pivot axis 30 of the lever is outboard of its free-moving end 28. When the lever 24 is squeezed towards the cross-piece member 2, corresponding movement of the shorter arm of the lever 32 pulls on the brake cable 34 relative to its sleeve 36 which in turn compresses a pair of brake callipers in the conventional way. The brake cable 34,36 runs inside the hollow cross-piece member 2 and thus does not contribute to drag.

As may be seen from FIG. 3 and particularly the cross-section of FIG. 5, the profile of the exposed part of the lever 24 is flattened—i.e. its horizontal width in the plane of movement is greater than its vertical height, parallel to its plane of movement. Indeed, the width is three times the maximum height in this embodiment. As may be more fully appreciated from FIG. 4, the brake lever 24 is located fully within the forward horizontal projection of the cross-piece member 2 which is defined as the area between the upper and lower delimitations indicated by dashed lines 38. This means that the brake lever 24 does not increase the frontal area presented by the handlebars beyond that which is inevitable from the cross-piece member 2. It should be further appreciated that the shape of the brake lever 24 in conjunction with its spacing from the cross-piece member 2 means that the airflow over the top and bottom surfaces respectively rejoins in the stagnation zone of the cross-piece member 2 i.e. at the point where the airflow divides to pass under or over the cross-piece member 2. This minimises turbulence and therefore drag.

In normal use the rider will spend most of his or her time holding the forwardly projecting handlebars 12,14 so as to minimise the frontal area the rider presents. This will mean that the brake assembly 20,24 is in the full air stream passing over the handlebars and therefore the reduction of wind resistance achieved by the shape and configuration of the brake lever 24 relative to the cross-piece member 2 can result in a significant power advantage at a given speed, for example 10 to 15 watts at 27 miles per hour which equates to approximately 1 second per mile. Should the rider need to apply the brakes, he or she will place their hands on the cross-piece member 2 just inwardly of, or partly covering, the brake hood 20 and curl their fingers over the brake lever 24 and squeeze towards the cross-piece member 2 which operates the brake callipers as described in relation to FIG. 4.

A second embodiment of the invention is shown in FIG. 6. This is identical to the first embodiment except that the brake lever 24 is not provided with a finial portion. This might marginally decrease the wind resistance further although in some circumstances other considerations might outweigh this.

FIG. 7 shows another embodiment which has a rectangular section lever 24′. Although the lever itself may not have quite the minimised wind resistance of the previous embodiments, since it is still located within the forward horizontal projection of the cross-piece member 2, a significant advantage over prior art arrangements is still enjoyed. A finial portion 28 is provided in the drawing shown although, as before, this could omitted.

FIGS. 8 to 10 show further embodiments of the invention which demonstrate some further possible variants on the first embodiment which have been envisaged.

FIG. 8 shows the lever hood 20 mounted inboard from the outer end of the cross-piece 2. In all other respects the embodiment is the same as the first. This enjoys all the advantages of the first embodiment.

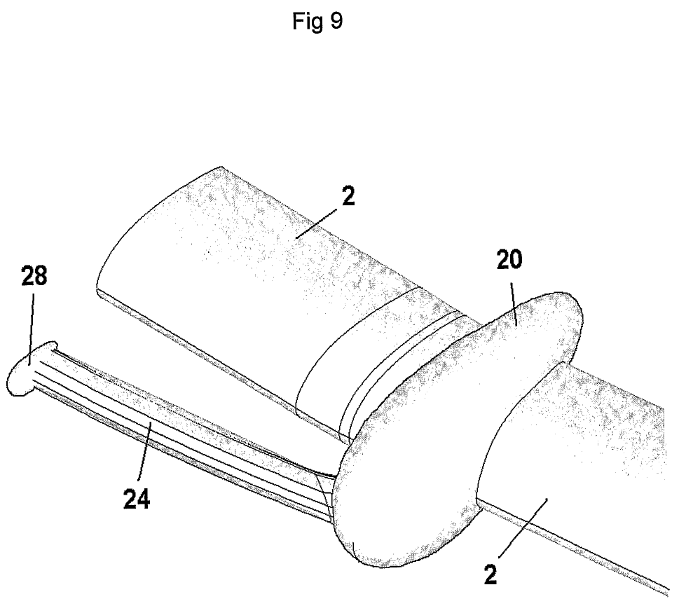

FIG. 9 also shows the lever hood 20 mounted inboard from the outer end of the cross-piece 2. However in this embodiment the lever 24 extends outwardly, away from the centre of the cross-piece 2.

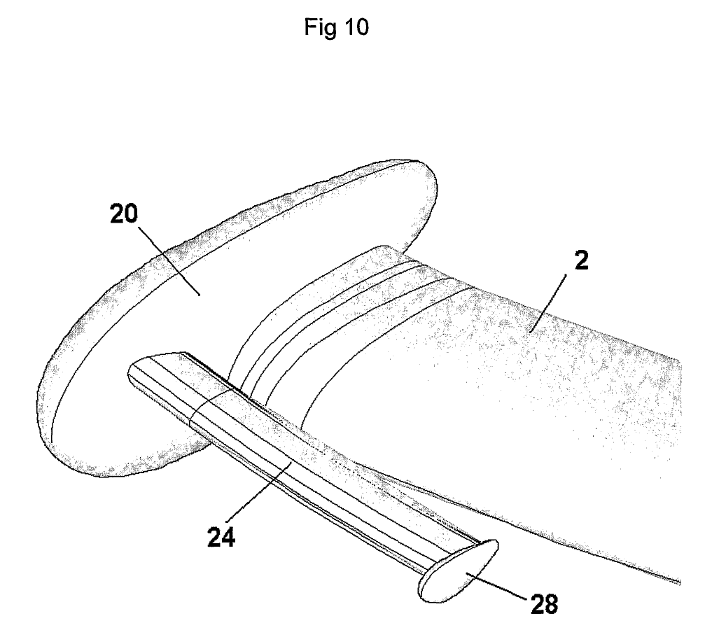

Finally, FIG. 10 shows the brake hood 20 disposed at the end of the cross-piece 2 as in the first embodiment; but this time the lever 24 extends horizontally from the brake hood 20 vertically offset from the plane of the cross-piece. Thus in this embodiment the lever 24 is not within the forward horizontal projection of the cross-piece. However the drop-shaped sectional profile of the lever 24 and the drop shape of the brake hood 20 still both contribute to a substantial reduction in drag as compared to known arrangements.

It will be appreciated by those skilled in the art that the foregoing description is merely exemplary of how the principles of the invention may be applied and that many further modifications and variations will be apparent without departing from the scope of the invention. For example, in the embodiments shown the brake lever is mounted horizontally although this is not essential. Thus, the lever need not be horizontal. This may be because the cross-piece is not horizontal (the brake lever still being parallel to it) or it could means that the lever is not parallel to the cross-piece member, whilst still realising some or all of the advantages of the invention.

FIGS. 11 to 13 show a handlebar assembly in accordance with a further aspect of the invention. A handlebar 101 includes a through-bore extending in a fore-aft direction of the bicycle. A boss extension 102 projects rearwardly from it and is formed as an annular split collar having a partly-spherical outer surface. The bore and collar 102 receive a handlebar extension member or extension grip 8, e.g. akin to the forwardly projecting handles of earlier embodiments or any other arrangement known per se in the art.

A clamp part 103 in the form of a split ring has a serrated inner surface and engages over the outer surface of the collar part 102. The clamp part is fixed to the collar by means of a bolt 105 which also serves to secure an armrest pad 106. As the bolt 105 is tightened the spilt collar 102 will clamp and secure the handlebar extension grip 108. The partly spherical outer surface of the collar member allows the clamp part 103 to be secured through a range of angles in two orthogonal directions in the manner of a ball and socket joint.

The depicted arrangement allows the extension member 108 to be adjusted axially and rotationally and further allows the armrest 106 to be adjusted by rotation about the clamp part 103 as well as in two different directions through the degree of movement afforded by the partly spherical collar surface. This allows adjustment to suit different riders of the same bicycle and/or to suit different objectives such as comfort and speed. Such adjustments are most often aimed at achieving the optimum aerodynamic presentation of the bicycle and rider for competitive speed trials.

A pair of the assemblies described above may be provided, one for each arm. The extension members may be separate or joined at the distal end. Alternatively a single fixing arrangement could be used for a composite grip extension.

1. A handlebar for attachment to a cycle, the handlebar comprising a generally horizontally extending cross-piece portion and at least one brake operating lever disposed at least partially within the forward horizontal projection of said cross-piece portion.

2. A handlebar as claimed in claim 1 wherein the longitudinal axes of the brake lever and cross-piece are substantially parallel.

3. A handlebar as claimed in claim 1 wherein said brake lever is entirely within the horizontal forward projection of the cross-piece portion.

4. A handlebar as claimed in claim 1 wherein the brake lever has a cross-sectional profile which has a width greater than its height.

5. A handlebar as claimed in claim 4 wherein the width is between two and three times the vertical height.

6. A handlebar as claimed in claim 1 wherein the lever has a cross-sectional profile which is generally curved with a leading edge blunter than its trailing edge.

7. A handlebar as claimed in claim 1 wherein said brake lever comprises a finial portion at the distal end thereof.

8. A handlebar as claimed in claim 7 wherein the finial portion is generally curved with a leading edge blunter than its trailing edge.

9. A handlebar as claimed in claim 1 wherein said brake operating lever is mounted for pivotal movement about a pivot axis which is outboard of the free end of the lever.

10. A handlebar as claimed in claim 1, including a brake lever hood and wherein said brake lever is pivotally mounted inside said brake lever hood, said brake lever hood having a cross-sectional profile which has a width greater than its height.

11. (canceled)

12. A handlebar as claimed in claim 1 wherein the brake lever is mounted directly into the cross-piece portion.

13. A handlebar as claimed in claim 1 comprising a brake cable passing inside the cross-piece portion.

14. A brake operating lever for attachment to a bicycle, said brake operating lever having a longitudinal handle portion extending from a pivot axis, the handle portion having a width greater than its height.

15. (canceled)

16. (canceled)

17. A brake lever as claimed in claim 14 wherein the width of the lever is between two and three times the height of the lever.

18. A racing bicycle comprising a handlebar including a cross-piece portion and one or more brake levers mounted so as to be substantially parallel with said cross-piece portion.

19. A bicycle as claimed in claim 18 comprising a pair of forwardly extending handles.

20. (canceled)

21. A brake assembly for a bicycle comprising a brake lever pivotally mounted with respect to a brake hood about a pivot axis, the brake hood having a cross-sectional profile in a plane parallel to the pivot axis which is wider in a direction normal to the pivot axis than its height in a direction parallel to the pivot axis.

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. A handlebar as claimed in claim 10 wherein said brake lever has a cross-sectional profile which is generally curved and which is blunter at its leading edge than its trailing edge.

44. A brake operating lever as claimed in claim 13 mounted for pivotal movement to a brake hood.

45. A handlebar having a brake operating lever as claimed in claim 13 mounted thereto.

46. A handlebar for a racing bicycle comprising a brake operating lever mounted for pivotal movement about a pivot axis which is outboard of the free end of the lever, said brake lever having a longitudinal axis substantially parallel to a cross-piece of said handlebar.

47. A brake assembly as claimed in claim 46 wherein the cross-sectional profile is generally curved and is blunter at its leading edge than its trailing edge.

48. A brake assembly as claimed in claim 46 wherein the width of the profile is between two and three times its height.

49. A handlebar comprising a cross piece for holding by a rider and a brake assembly as claimed in claim 21 disposed on said cross piece.

50. A handlebar as claimed in claim 49 wherein the brake lever is substantially parallel to the cross piece.
